(19) United States
(12) Patent Application Publication
(10) Pub. No.: US 2005/0190274 A1
(43) Pub. Date: Sep. 1, 2005

(54) Imaging device and image generation method of imaging device

(75) Inventors: Seiji Yoshikawa, Tokyo (JP); Ryuichi Sawada, Tokyo (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 11/069,896

(22) Filed: Feb. 28, 2005

(30) Foreign Application Priority Data
Feb. 27, 2004 (JP) 2004-053831
Feb. 27, 2004 (JP) 2004-053832
Feb. 27, 2004 (JP) 2004-053833
Jul. 27, 2004 (JP) 2004-218204
Jul. 27, 2004 (JP) 2004-218205

(51) Int. Cl. H04N 5/335; H04N 9/083; H04N 9/04; H04N 3/14; H04N 5/76

(52) U.S. Cl. 348/231.99; 348/273

(57) ABSTRACT

An imaging device having nonconventional and a completely new imaging method and an image generation method of the imaging device, wherein the imaging device has an image processing section generating a first compressed image compressed high image data with intra-frame compression in capturing single moving image data and a second compressed image compressed low image data with inter-frame compression in a front period and/or in a rear period of a period generating the first compressed image as one stream, where the imaging device generates still image data having high-resolution indicating one screen designated by decompression and decoding by the second compressed image and the other compressed image including the first compressed image when one screen of a second compressed image is designated.

### CROSS REFERENCES TO RELATED APPLICATIONS

The present invention contains subject matter related to Japanese Patent Applications No. 2004-053831, 2004-053832 and 2004-053833 filed in the Japan Patent Office on Feb. 27, 2004, and Japanese Patent Applications No. 2004-218204 and 2004-218205 filed in the Japan Patent Office on Jul. 27, 2004, the entire content of which being incorporated by reference.

### BACKGROUND OF THE INVENTION

1. Field of the Invention

The present invention relates to an imaging device such as a digital camera and an imaging method, in more detail, relates to an imaging device handling an image retrieved as a moving image mainly (comparatively small number of pixels) and an image able to be handled as a still image (comparatively large number of pixels) on a same stream and an image generation method of an imaging device.

2. Description of the Related Art

There has been proposed a digital camera which compresses a digital video signal based on an imaging signal captured by using an imaging element by discrete cosine transform (DCT) or wavelet transform and variable-length code and records in recording media such as a magnetic tape, a magnetic disc and an optical disc.

Such the digital camera has a moving image recording mode and a still image recording mode, records in recording media by performing a compression recording for a moving image in the moving image recording mode, and records in recording media by performing a compression recording for a still image in the still image recording mode.

Imaging devices able to capture a still image having high-resolution in capturing a moving image have been proposed variously as shown as a first imaging device to a seventeenth imaging device hereinafter.

A first imaging device is an imaging device of capturing one frame still image having high-resolution automatically at every cycle of integral times a frame cycle of a moving image, and it reads out pixel signals with thinning when capturing a moving image and it reads out all pixel signals by dividing to two fields when capturing a still image (refer to Japanese Unexamined Patent Publication (Kokai) No. 2002-44531).

A second imaging device shoots a still image at a predetermined period in capturing a moving image (refer to Japanese Unexamined Patent Publication (Kokai) No. H7 (1995)-245722).

A third imaging device is a device capturing a still image having high-resolution by an operation of an operator or at constant interval automatically, where the still image is recorded as still image data, the moving image is recorded as moving image data, an indicator indicating an existence of a recording of the still image is displayed in reproducing the moving image and the display is switched to the still image by the operation of the operator (refer to Japanese Unexamined Patent Publication (Kokai) No. H9(1997)-51498).

A fourth imaging device is an image recording device capturing a still image by a shutter button operation of an operator with capturing a moving image in a predetermined period, where the captured still image is corrected by using the moving image in front and/or in rear of the still image.

A fifth imaging device is a moving image recording device such as a camcorder capturing a highly fine still image when operating a shutter button in capturing a moving image, where the highly fine still image in operating the shutter button is encoded as an intra-coded image (I picture) coercively (refer to Japanese Unexamined Patent Publication (Kokai) No. H7(1995)-284058).

A sixth imaging device is a device able to capture a still image in capturing a moving image, where, when a desired still image does not exist, an image having high-resolution corresponding to a desired moving image is synthesized with the desired moving image and a still image associated with that (refer to Japanese Unexamined Patent Publication (Kokai) No. 2002-51252).

A seventh imaging device is a digital camera starting to record a moving image by pushing a shutter button half and capturing a still image by pushing the shutter button completely in recording the moving image, where the still image data captured in capturing the moving image is recorded by being associated with the moving image (refer to Japanese Unexamined Patent Publication (Kokai) No. 2002-84442).

An eighth imaging device is an image recording device capturing a still image by a shutter button operation of an operator in capturing a moving image, where the captured still image is corrected by using the moving image in front and/or in rear of the still image (refer to Japanese Unexamined Patent Publication (Kokai) No. H7(1995)-143439) A ninth imaging device is a device recording data of a moving image and a still image as a series of files, where the moving image is recorded by Main Profile at Main Level (MP@ML) and the still image is recorded by Main Profile at High Level (refer to Japanese Unexamined Patent Publication (Kokai) No. H11(1999)-234623).

A tenth imaging device temporarily stores a series of continuous capturing image and records only images selected by an operator in a memory card (refer to Japanese Unexamined Patent Publication (Kokai) No. 2001-78136).

An eleventh imaging device rerecords a recorded image by performing processing such as subtractive color, cutout or reduction of resolution (refer to Japanese Unexamined Patent Publication (Kokai) No. 2002-10209).

A twentieth imaging device performs mixing of charge in a vertical direction of a CCD in capturing a moving image and raises a gain by, for example, 6 dB by a level controller without performing pixel mixing of the CCD (refer to Japanese Unexamined Patent Publication (Kokai) No. 2003-125278).

A thirteenth imaging device is possible to generate a screen of ½ pixel which signals of four pixels are averaged (a gain is upped four times) and a screen of normal pixel (refer to Japanese Unexamined Patent Publication (Kokai) No. H4(1992-17087).

A fourteenth imaging device decides number of lines to be added pixels in accordance with brightness of a subject (refer to Japanese Unexamined Patent Publication (Kokai) No. H4(1992)-172073).

A fifteenth imaging device decides a mode not to be added pixels and a mode to be added pixels in accordance with brightness of a subject (refer to Japanese Unexamined Patent Publication (Kokai) No. H10(20.00)-150601).

A sixteenth imaging device performs addition imaging in an initial setting and performs non-addition imaging by changing setting by a user (refer to Japanese Unexamined Patent Publication (Kokai) No. 2001-359038).

A seventeenth imaging device is set in an addition output mode when the luminance of a subject is low and is set in a non-addition output mode when the luminance of a subject is not low (refer to Japanese Unexamined Patent Publication (Kokai) No. 2003-319407).

Meanwhile, in each above-mentioned imaging device, usually, when capturing an image of a moving image level, exposing a rolling shutter repeatedly and transmitting data are performed sequentially. Further, when performing continuous capturing of the still image, the rolling shutter is used repeatedly similar to the above or a mechanical shutter is used.

Here, in capturing an image by only the rolling shutter, distortion of the image occurs in the top and the bottom of the image. However, it can be permitted because it is the moving images.

However, when capturing the still images, the distortion of the images may not be permitted. Therefore, the mechanical shutter and the global shutter become necessary, however, the mechanical shutter drive has a limit to perform a continuous capturing at unlimitedly high speed.

Further, in a digital camera and so on, for obtaining a desired image having high-resolution, an operator observes an imaging subject and needs to operate a release button at the timing the operator aims.

However, even operating at the timing the operator aims, a desired image may not be necessary obtained, a continuous capturing function resolving this has been utilized.

However, when capturing image having high-resolution by, for example, several scenes at a second for ten seconds, the recorded image data becomes enormous and it has little practicability in considering capacity of a memory card and so on.

Further, in such a digital camera having a continuous capturing function, when continuous capturing still images having high-resolution having several million pixels, since an upper limit largely depends on readout processing ability of a CCD and so on, several scenes at a second becomes to an upper limit, if a desired image is that of a subject with fast movement, it becomes difficult to obtains the desired image even, for example, using the continuous capturing.

Further, in a digital camera having s first mode recorded a moving image and a still image having different resolution from the moving image as one stream, and a second mode performing a capturing of only a moving image, since the captured data in the first mode has a still image having high-resolution at intervals, saved file size becomes larger than the case of capturing a simple moving image. As a result, a capacity of a recording memory becomes larger and there is a disadvantage that it is difficult to assure a practical recording capacity.

Therefore, an imaging device is developed newly, where the imaging device allows obtaining desired still images having high-resolution without regard for speed of the continuous capturing, with suppressing a recording capacity and without regard of an operator for shutter timing.

### SUMMARY OF THE INVENTION

The present invention is a completely new matter from such a development, the above-mentioned issues such as obtaining a still image having high-resolution is not a back ground of the present invention. An object of the present invention is to provide an imaging device having a nonconventional and completely new imaging method and an imaging generation method of the imaging device.

According to a first aspect of the present invention, there is provided an imaging device having an imaging element on which an optical image of a subject is formed, a signal processing system reading out high image data having high-resolution or low image data having low-resolution from the imaging element and performing predetermined image processing for read out image data, wherein the signal processing system includes an image processing section generating a first compressed image compressed the high image data with intra-frame compression in capturing one moving image data and a second compressed image compressed the low image data with inter-frame compression in a front period and/or in a rear period of a period generating the first compressed image as one stream.

Preferably, the high image data includes image data read out from the imaging element without thinning or image data read out with thinning by any amount of thinning by the image processing system, and the low image data includes image data read out from the imaging element with thinning by any amount of thinning to become lower resolution than the high image data by the image processing system.

Preferably, the imaging device has a global shutter function and a rolling shutter function as shutter function, wherein the image processing section generates a first compressed image by image data captured with the global shutter and generates a second compressed image by image data captured with the rolling shutter.

Preferably, the image processing section corrects an image level of the first compressed image and an image level of the second compressed image to be an approximately equivalent level.

Preferably, when one screen of the second compressed image is designated, the image processing section generates still image data having high-resolution indicating the one designated screen by decompression and decoding a screen of the second compressed image by the other image including the first compressed image in front and/or in rear of the second compressed image.

Preferably, the imaging device further has a stream output unit outputting a continuous video stream having low-resolution by using the first compressed image having high-resolution and the second compressed image having low-resolution, a discrimination unit discriminating whether the first compressed image is high-resolution or low-resolution, and a discrimination signal output unit outputting a signal indicating whether the first compressed image is high-resolution or low-resolution by the discrimination unit.

Preferably, the imaging device has a storing unit storing a series of stream data of the first compressed image and the second compressed image, wherein when one screen of the first compressed image on one stream data is designated, the image processing section reduces resolution of the first compressed image to the equivalent degree of the second compressed image, replaces the first compressed image in the stream data to the first compressed image which resolution is reduced and restores it in the storing unit.

Preferably, the imaging device has a storing unit storing a series of stream data of the first compressed image and the second compressed image, wherein the image processing section reduces resolution of all of a plurality of the first compressed images on one stream data to the equivalent degree of the second compressed image, replaces the first compressed image in the stream data to the first compressed image which resolution is reduced and restores it in the storing unit.

Preferably, when reading out image data from the imaging element with thinning, the signal processing system generates thinning data by performing integration processing of concolorous vicinity pixels.

Preferably, the image processing section corrects an image level of the first compressed image and an image level of the second compressed image to be an approximately equivalent level by correcting an image level of the first compressed image based on an R level performed integration processing readout of the second compressed image.

Preferably, the image processing section corrects an image level of the first compressed image and an image level of the second compressed image to be an approximately equivalent level by maintaining an image level of the first compressed image and correcting an image level of the second compressed image by dividing an integration amount of the integration processing.

Preferably, the signal processing system includes a pixel average readout circuit able to average and read out a plurality of pixel data from the imaging element, a pixel addition readout circuit able to add and read out a plurality of pixel data from the imaging element, a luminance detector detecting the luminance of a subject, and a selector selecting either output of the pixel average readout circuit and the pixel addition readout circuit by detection output of the luminance detector.

Preferably, the signal processing system includes an added pixel changing circuit changing number of added pixels in the pixel addition readout circuit based on output of the luminance detector, a converter converting output data of the pixel addition readout circuit or the pixel average readout circuit selected by the selector from analog data to digital data, and a reference voltage changing circuit changing a reference voltage value of the converter based on output of the luminance detector or output of the added pixel readout circuit.

According to a second aspect of the present invention, there is provided An image generation method of an imaging device performing predetermined image processing for image data read out from an imaging element having steps of reading out high image data having high-resolution or low image data having low-resolution from the imaging element by making an optical image of a subject to form on the imaging element, generating a first compressed image by compressing the high image data with intra-frame compression in capturing single moving image data, generating a second compressed image by compressing the low image data with inter-frame compression in a front period and/or in a rear period of a period generating the first compressed image, and generating a first compressed image compressed the high image data with intra-frame compression and a second compressed image compressed the low image data with inter-frame compression in a front period and/or in a rear period of a period generating the first compressed image as one stream.

### BRIEF DESCRIPTION OF THE DRAWINGS

These and other objects and features of the present invention will become clearer from the following description of the preferred embodiments given with reference to the accompanying drawings, wherein:

FIG. 1 is a block diagram showing a first embodiment of an imaging device according to the present invention;

FIG. 2 is a view for explaining an operation in a stream data changing mode in the present embodiment;

FIG. 3 is a view showing an example of an imaging element (image sensor) in use of a rolling shutter;

FIG. 4A to FIG. 4F are views showing examples of control waveform of images when assuming lines from LA to LF exist in the element as shown in FIG. 3;

FIG. 5 is a view showing an example of a control waveform of an image when assuming lines from LA to LF exist in the element as shown in FIG. 3 in use of a global shutter;

FIG. 6 is a conceptual view of an image sensor;

FIG. 7 is a view showing a concept of a correction processing according to the present embodiment;

FIG. 8 is a block diagram of a stream of mixing of a moving image (low pixel) and a still image (high pixel);

FIG. 9 is a block diagram showing a second embodiment of an imaging device according to the present invention;

FIG. 10 is a conceptual view of an image sensor and a view for explaining a pixel control method in the present second embodiment;

FIG. 11 is a block diagram showing an example of a configuration of a readout circuit according to a second embodiment;

FIG. 12 is a block diagram showing a third embodiment of an imaging device according to the present invention, and

FIG. 13 is a block diagram showing an example of a configuration of a readout circuit according to a third embodiment.

### DESCRIPTION OF THE PREFERRED EMBODIMENTS

Preferred embodiments of the present invention will be described with reference to the accompanying drawings.

### First Embodiment

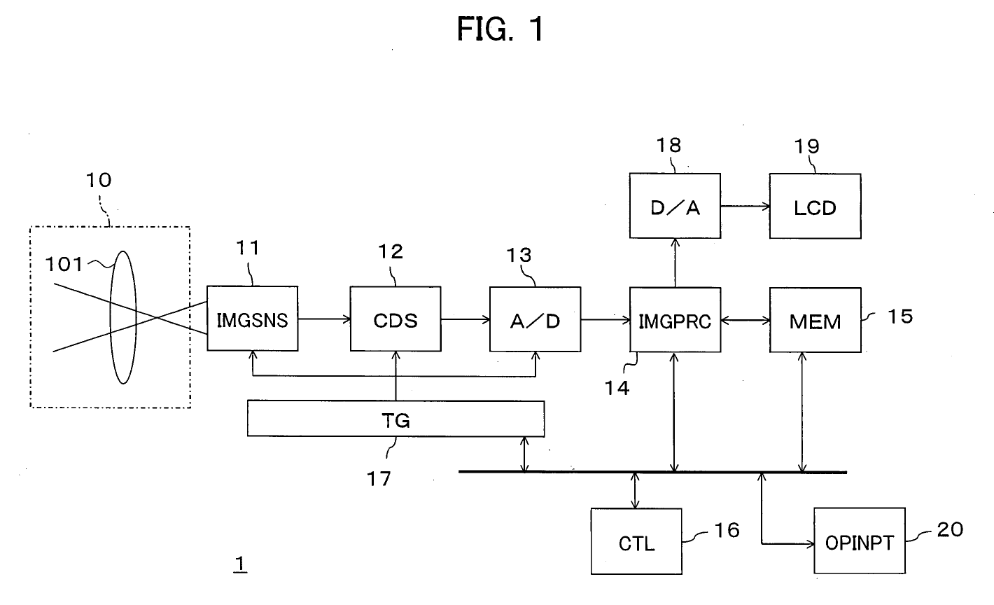

FIG. 1 is a block diagram showing a first embodiment of an imaging device according to the present embodiment. The present imaging device 1 has components classified generally as an optical system, a signal processing system, a recording system, a display system and a control system.

The imaging device 1 according to the present embodiment generates a first compressed image by compressing image data of high pixel with intra-frame compression in the signal processing system in capturing a moving image, generates a second compressed image by compressing image data of low pixel with inter-frame compression in a front period and/or in a rear period of the period generating the first compressed image. Further, when a screen of the second compressed image is designated, the imaging device 1 generates still image data having high-resolution showing a designated screen by decompressing and decoding by the other compressed image including the second compressed image and the first compressed image in front and/or in rear of it.

Then, the imaging device 1 according to the present embodiment uses rolling shutter function in combination with global shutter function in capturing data of a moving image.

Further, the imaging device 1 according to the present invention corrects image levels of the first compressed image having high-resolution and the second compressed image having low-resolution to approximately equivalent level and controls, for example, to make output levels of the first and second compressed images constant.

Further, the imaging device 1 according to the present invention has three modes, that is, a playback mode, a still image reproduction mode and a stream data changing mode.

Hereinafter, composition and function of each portion will be explained.

The optical system includes a lens optical system 10, and an image sensor (IMGSNS) 11 such as a CMOS sensor.

The lens optical system 10 includes an optical lens opposite to a subject and a not illustrated optical low pass filter and so on. In the lens optical system 10, an optical image of the subject is condensed by the optical lens 101 and an image of the subject is formed on the image sensor 11.

The image sensor 11 as an imaging element has, for example, a CMOS image sensor provided a color filter and photoelectric-converts the image of the subject formed by the lens optical system 10.

The image sensor 11 has shutter function including the global shutter function and the rolling shutter function.

The global shutter function and the rolling shutter function are used selectively in accordance with a control of the control system, and the shutter function is controlled to make it to capture images by the global shutter while making it to capture pixels by the rolling shutter. Namely, the rolling shutter function and the global shutter function are used together in capturing data of one moving image.

The signal processing system has a correlated double sampling (CDS) circuit 12 for reducing noise by sampling an electric signal output from the image sensor 11, an analog/digital (A/D) converter 13 converting an analog signal output by the CDS 12 to a digital signal and an image processing section (IMGPRC) 14 performing predetermined image processing as mentioned later for the digital signal output by the A/D converter 13.

The image processing section 14 according to the present embodiment generates a first compressed image by compressing data of a pixel captured by the global shutter with intra-frame compression and generates a second compressed image by compressing pixel data captured by the rolling shutter with inter-frame compression in a front period and/or in a rear period of a period generating the first compression image.

As described in detail later, the image processing section 14 generates the first compressed image by reading out the image data from the image sensor without thinning, and generates the second compressed image by reading out the image data from the image sensor with thinning.

The image processing section 14 compresses image data of high pixel with intra-frame compression in generating the first compressed image, and it compresses image data of low pixel with inter-frame compression in generating the second compressed image.

Further, when generating the second compressed data by reading out from the image sensor with thinning data, the image processing section 14 performs integral processing of concolorous vicinity pixels and reads out with thinning.

The image processing section 14 has the function to correct an image level of the first compressed image and an image level of the second compressed image to an approximately equivalent level.

The image processing section 14, as described in detail later, has function correcting an image level of the first compressed image and an image level of the second compressed image to an approximately equivalent level by performing integral processing to correct the image level of the first compressed image based on an R level of which the second compressed image is read out.

Further, the image processing section 14 has function to correct an image level of the first compressed image and an image level of the second compressed image to an approximately equivalent level by maintaining the image level of the first compressed image and correcting the image level of the second compressed image by dividing an integral amount of the integral processing.

When a screen of the second compressed image is designated, the image processing section 14 has function to generate still image data having high-resolution showing this designated screen by decompression and decoding processing by the other compressed image including the second compressed image and the first compressed image in front and/or in rear of the second compressed image.

When a screen of the first compressed image on data of one stream is designated, the image processing section 14 reduces resolution of the first compressed data to the equivalent degree as the second compressed image, replaces the first compressed image data of one stream data to a first image data reduced resolution and rerecords it to a memory 15 again.

The image processing section 14 reduces resolution of a plurality of the first compressed image of one stream data to the equivalent degree as the second compressed image in block, replaces the first compressed image of one stream data to a first compressed image reduced resolution and rerecord it to the memory 15 again.

The image processing section 14 having the above mentioned function performs the following processing in the above-mentioned three modes, that is, a playback mode, a still image reproduction mode and a stream data changing mode.

The image processing section 14 generates a contiguous video stream having low-resolution with a first compressed image having high-resolution and a second compressed image having low-resolution and displays it in the playback mode.

In the still image reproduction mode, in playing back a contiguous video stream having low-resolution by using a first compressed image having high-resolution and a second compressed image having low-resolution, a specific image is designated by an operator.

In the still image reproduction mode, when an image designated by the operator is a first compressed image, the image processing section 14 outputs highly precise still image of the first compressed image and displays it. Further, when the designated image is a second compressed image, the image processing section 14 generates and outputs an image having high-resolution corresponding to an image designated from at least one or more screen of that image, the first compressed image in front and/or in rear of the second compressed image and the second compressed image and displays it.

In the still image reproduction mode, contiguous images having low-resolution such as thumbnails with first compressed images having high-resolution and second compressed images having low-resolution are displayed, designation of the images is performed by the key operation and so on by the operator and the image processing section 14 performs similar processing.

In the stream data changing mode, the image processing section 14 performs processing to replace all the first compressed images having high-resolution in one designated stream data to the first compressed images having low-resolution automatically by the key operation and so on by the operator.

The file size can be reduced by this processing of the stream data changing mode. This processing will be described in detail further.

Even if a moving image file is stopped at a certain image in playing back it, since the resolution of the moving image is low, it becomes low quality even if this is saved as a still image or printed out.

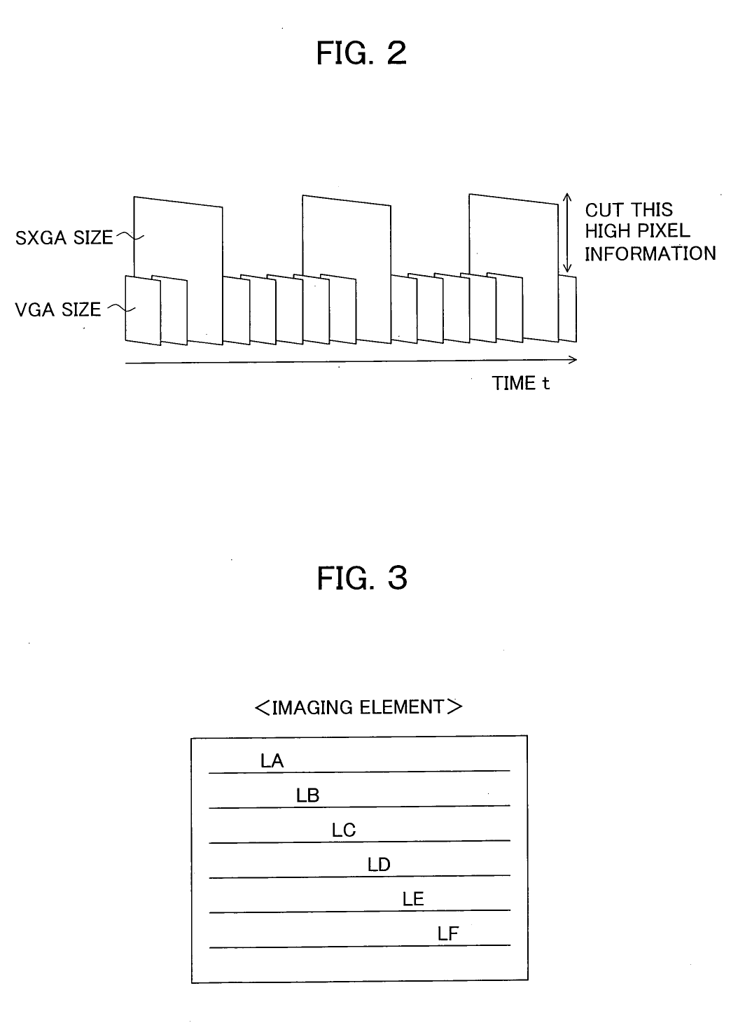

For resolving this, as shown in FIG. 2, the imaging device 1 has function that an image (for example, VGA size) of a plurality of frames (for example, 30 frames) per one second is captured, a file is formed as a moving image, several frames (for example, 5 frames) per one second in the moving image file is captured as a still image having higher-resolution than the moving image (for example, SXGA size) and it is recorded as one stream.

This enables to save and print as a high quality still image by inserting several still images having high-resolution in a simple moving image file and compensating an image of VGA size and a still image having high-resolution captured at regular intervals even if it is stopped everywhere.

However, if nothing is done, a file size may become large because the still image having high-resolution exists in the moving image file, a remainder capacity of the recording memory 15 having a limitation in a capacity may be occupied.

Accordingly, in the image processing section 14 of the imaging device 1 according to the present embodiment, when the operator judged it is not necessary to print out images captured in a mode of mixing of a still image and a moving image, as shown in FIG. 2, the file size can be reduced by converting a still image having high-resolution (SXGA size) to an image having low-resolution (VGA size) from a data file and forming a simple moving image file.

This processing can be executed by a key operation and so on by the operator and a remainder capacity of the memory can be spared. Furthermore, since high-resolution information of the still image is only cut, there is no problem such as reduction of image quality when playing back it as a moving image.

Further, the image processing section 14 has a discrimination function in addition to the stream output function outputting a video stream. The discrimination function is that, when outputting contiguous video streams having low-resolution with a first compressed image having high-resolution and a second compressed image having low-resolution in the above-mentioned three modes, the function discriminates whether the first compressed image in outputting simultaneously is an image having high-resolution or an image having low-resolution and output a signal showing whether the first compressed image is an image having high-resolution or an image having low-resolution.

Concretely, when the first compressed image exists on a multi-display screen divided by N, a mark able to discriminate whether it is an image having high-resolution or an image having low-resolution is displayed near the screen of the first compressed image. Further, in a display mode of a moving image, a mark indicating it is an image having high-resolution is displayed so as to super impose.

Further, as an additional mode, a flag signal indicating whether an image data is higher or lower resolution than each of a first compressed image is added and transmitted together in transmitting the image data to the other device and recording media such as a memory card.

Further, in a file list display screen indicating video streams, data indicating whether a first compressed image having high-resolution exists in data of one stream or not, how many screens exist when it exists and position data (time information) on existing stream data is transmitted together.

The recording system includes a memory 15 storing a program for control executed by a control section and compressed data of compressed image generated by an image processing section 14.

In the memory 15 as a storing unit, a series of stream data of the first and the second compressed images is stored by the image processing section 14.

The display system has a digital/analog (D/A) converter 18 making image data stored in an embedded image memory to analog data and a display section 19 including a liquid crystal display (LCD) and so on function as a finder by displaying inputted images.

The control system has an image sensor 11, a CDS 12, a timing generator 17 controlling operation timing of the A/D converter 13, an operation input section (OPINPT) 20 for inputting shutter operation by the user (operator) and the other commands, an image processing section 14 and a control section 16 including a central processing unit (CPU) etc. reading out a control program stored in the memory 15 and controlling the whole of the imaging device 1 based on a control program read out and commands from user inputted from the operation input section 20.

When capturing image data having different number of pixels on one stream, the control section (CTL) 16 controls so as to use the rolling shutter function in the case of moving images and use the global shutter in the case of still images.

Here, when capturing image data having different number of pixels on one stream, the rolling shutter is used for the moving image, and for the still image, it is judged whether to use the rolling shutter or the global shutter by a camera condition.

Namely, in a system where the control section 16 retrieves different number of pixels from an imaging element in a series of operation, when handling images retrieved as moving images (comparatively small number of pixels) and images handled as still images (comparatively large number of pixels) on the same stream, the imaging device 1 according to the present embodiment do not use the global shutter in the case of capturing low pixel, and judges whether the global shutter (or mechanical shutter) is used or not only in the case of capturing high pixel.

Usually, when capturing images of a moving image level, a repeated exposure of the rolling shutter and a data transmission are performed sequentially. Further, when performing the continuous capturing of the still images, it is controlled by using the rolling shutter continuously in a way similar to the above, using the mechanical shutter or using the global shutter.

Here, distortion of images occurs in the top and the bottom of the image in capturing images by only using the rolling shutter. However, it can be permitted because they are the moving images.

However, when capturing the still images, distortion of the images may not be permitted. Therefore, the mechanical shutter and the global shutter become necessary. Since the mechanical shutter drive has a limit to perform a continuous capturing at unlimitedly high speed, the global shutter becomes indispensable.

Here, when capturing image data having different number of pixels on one stream, the rolling shutter is used for the moving image, and for the still image, it is judged whether to use the rolling shutter or the global shutter by a camera condition.

FIG. 3 is a view showing an example of an imaging element (image sensor) in use of the rolling shutter.

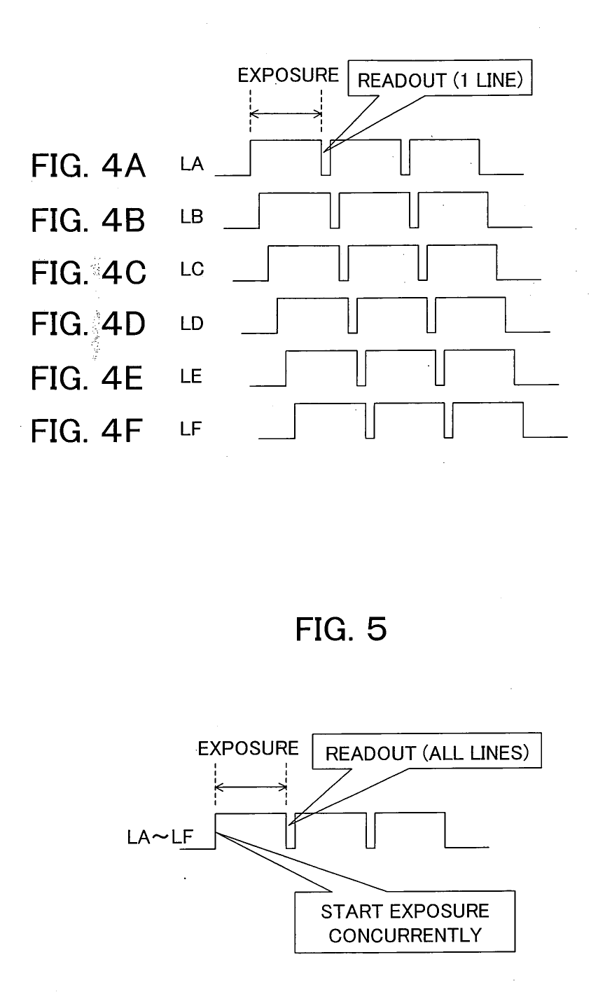

As shown in FIG. 3, when assuming lines from LA to LF exist in the element, the control of the image becomes as shown in FIG. 4A to FIG. 4F.

Usually, when using this rolling shutter, since difference of exposure time occurs from LA to LF, the distortion of the image occurs.

FIG. 5 is a view showing an example of a control waveform of an image when assuming lines from LA to LF exist in the element as shown in FIG. 3.

In this case, since the difference of exposure time does not occur in use of the global shutter, distortion of the image does not occur. However, exposure ends at the same time, it is necessary to start exposure for all elements at the same time. Further, since image transmission starts simultaneously, time longer than the rolling shutter is necessary.

Therefore, the rolling shutter has an advantage that the capture speed is higher than the global shutter and the mechanical shutter. It has a disadvantage that distortion of images occurs between the lines.

Compared with this, the global shutter (or the mechanical shutter) has an advantage that data not making distortion of images occur can be obtained. While, capturing speed is slower than the rolling stutter.

When estimating these advantage and disadvantage as a camera system in advance, in the case that distortion of an image may be permitted and speed is necessary, the capture is performed by the rolling shutter even though images of any number of pixels, and in the case of giving priority to image quality, the global shutter is used for that image data in accordance with the common status.

Note that, not applied only to a system retrieving difference number of pixels from an imaging element in a series of operations, it may be similar to the case of handling equivalent number of pixels.

In the imaging device 1, an optical image of a subject is entered to the image sensor 11 via the lens optical system 10 and is photoelectric-converted by the image sensor 11 to become an electric signal. The obtained electric signal is removed noise components by the CDS 12 and digitized by the A/D converter 13, and then the digital signal is stored temporarily in an embedded image memory by the image processing section 14.

In the normal state, the image memory embedded in the image processing section 14 is overwritten with an image signal constantly at a constant frame rate by a control for the signal processing system by the timing generator 17. The image signal of the image memory embedded in the image processing section 14 is converted to an analog signal by the D/A converter 18 and the corresponding image is displayed on the display section 19.

The display section 19 bears a role of a finder of the imaging device 1. After an user pushed down (operates) a shutter button included in the operation input section 20, the control section 16 controls the signal processing system for the timing generator 17 to hold an image signal right after the shutter button is pushed down, namely, so that the image memory of the image processing section 14 is not overwritten with the image signal. Then, the image data held in the image memory of the image processing section 14 is compressed by a predetermined method and recorded in the memory 15.

Next, characteristic processing executed in the image processing section 14 will be explained.

<Gain Variable Power or Average Control in Capturing Images having Different Number of Pixels>

In the system retrieving different number of pixels from the imaging element in a series of operations, when handling an image retrieved as a moving image (comparatively small number of pixels) and an image able to be handled as a still image (comparatively large number of pixels) on the same stream, when capturing small number of pixels, the output pixels include integrated pixel data of the same color pixel of at least one or more pixels. When capturing large number of pixels, it becomes to number of pixels less than the integrated number of pixels when capturing small number of pixels.

The output of one pixel of the output pixels is different due to a difference of original integrated number of pixels. When judged the different output of each a pixel is the same, since images having different luminance are continuously generated particularly in the image processing, curious images are generated.

To resolve that, a circuit of a digital gain (or an analog gain) in accordance with the number of pixels, or a circuit averaging by the number of pixels is arranged, and a circuit correcting generation of a difference of the image output of each pixel is arranged in a portion that the pixel is output in the image processing section 14.

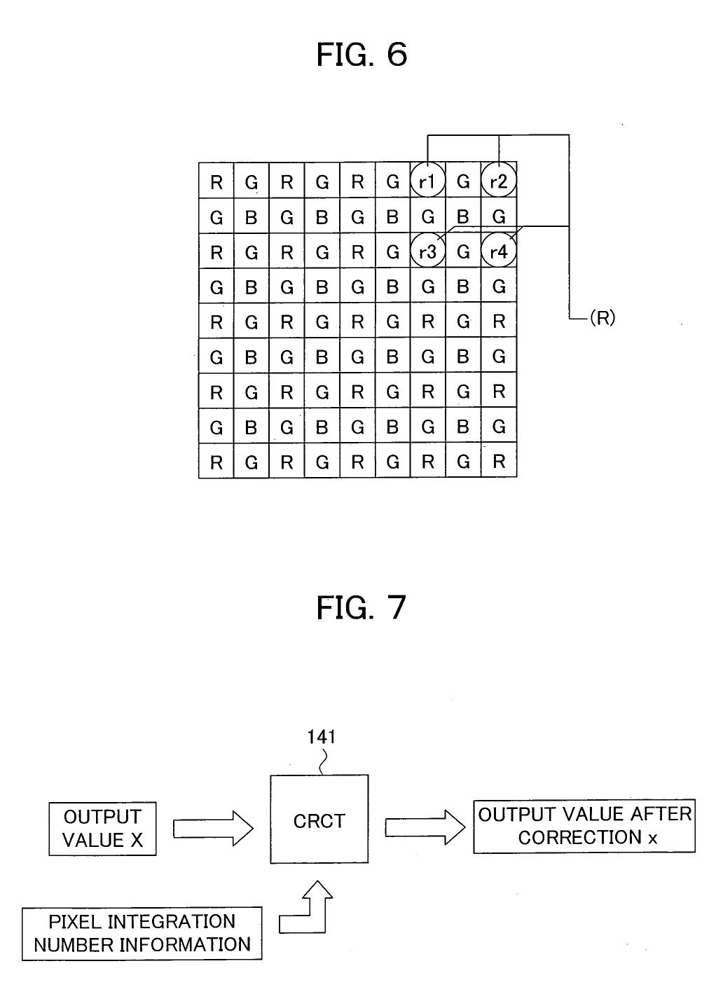

FIG. 6 is a conceptual view of the image sensor. Note that, R, G and B in FIG. 6 indicate red, green and blue of the three primary colors.

In a view of sensor as shown in FIG. 6, in capturing a still image (high pixel), pixels corresponding approximately all pixels are captured. On the other hand, in the case of a moving image (low pixel), capture of all pixels is not necessary and capture of a minimum necessary pixel is performed because number of captured pixels is allowed to be small.

Usually unnecessary pixels are eliminated by simple thinning, however, when quality of a moving image is required such as a moving image, the peripheral R is integrated and retrieved as shown (R) in FIG. 6.

The pixel data output at that time is different between the case of a still image (high pixel) and a moving image (low pixel) and the difference of output level arises.

In order to correct the difference of the output level, at the time of the high pixel and the low pixel, the output levels of the still image and the moving image are corrected by multiplying the output data by a coefficient in accordance with a ratio of the integrated pixels or averaging the integrated pixel data by a coefficient in accordance with the number of the integrated pixels.

FIG. 7 is a conceptual view of correction processing according to the present embodiment. In FIG. 7, the above-mentioned processing is performed in a correction circuit (CRCT) 141.

<S/N Information Control when High Pixel>

In the system retrieving different number of pixels from the imaging element in a series of operations, when handling an image retrieved as a moving image (comparatively small number of pixels) and an image able to be handled as a still image (comparatively large number of pixels) on the same stream, in the case of the low pixel capture, the output pixels include integrated pixel data of the same color pixel of at least one or more pixel. In the case of high pixel capture, it becomes to number of pixels less than the integrated number of pixels when capturing small number of pixels.

In the case of low pixel capture, the data of the one pixel is generated with the integration of a plurality of pixels. In comparison with data in capturing high pixel, the output becomes large by the number of the integration. Further, as S/N, it is a superior information generally in a view of S/N in comparison with S/N of high pixel.

In the present embodiment, image quality improvement of the integrated data (high image data (information of a still image) utilizing the S/N information of the information of moving image and defined as it has much noise comparatively) is achieved.

The output of one pixel of the output pixels is different due to a difference of original integrated number of pixels. When judged the different outputs of each pixel is the same, since images having different luminance are continuously generated particularly in the image processing, curious images are generated.

To resolve that, as mentioned above, a circuit of a digital gain (or an analog gain) in accordance with the number of pixels, or a circuit averaging by the number of pixels is arranged, and a circuit correcting generation of a difference of the image output of each pixel is arranged in a portion that the pixel is output.

When referring to FIG. 6, FIG. 6 shows a view that four pixels are integrated.

In comparison with a single pixel, (R) information output from this becomes image output having about four times output. This works advantageously by about two steps at the point of ISO sensitivity. When low pixel outputting, this (R) information is utilized full-time.

When high pixel outputting, compared with low pixel outputting, single pixel output information r1 to r4 is utilized.

For adjusting level of a signal output from the image sensor 11, on the same stream, this single pixel information r1 to r4 is corrected by gain-up due to analog or digital data. This gain-up causes critical deterioration for S/N.

Since (R) information is integration information of r1 to r4 originally, it can be analogized from (R) information having few noises.

On the contrary, a single pixel rn becomes the gain-upped Rn finally.

Namely, the sum of respectively gain-upped data (R1+R2+R3+R4) must be equivalent to (R) that is the sum of original (r1+r2+r3+r4) logically. However, next relation is established generally because of a noise increase such as the gain-up.
r1+r2+r3+r4>>(R)

Therefore, when a component (R1+R2+R3+R4) coincident with moving image information (R) and an address of the single pixel exists, the contents returned to the original component (r1+r2+r3+r4) with (R) that should be composed of its integration by calculating back with the gain applied to each data. Then, when the relation
r1+r2+r3+r4>>(R)
is established, the amount that exceeds it is judged to be a noise, a correction subtracting N1 to N4 corresponding to n1 to n4 in
(r1−n1)+(r2−n2)+(r3−n3)+(r4−n4)
is performed to each Rn.

In this case, n1 to n4 are possible to be constant values, possible to be an output ratio of r1 to r4 and possible to be a mix of them. It depends on what noise is dominant about the noise component in the camera system.

Further, since it may include an error margin in the calculation (quantization error and so on), right-hand side of the above equation is not fixed at (R) but it is (R)±x.

x at this time is an error correction number arising from the error such as a round-off error.

<Method of Generating Still Image Quality Even in Playback in Moving Image Timing>

In the system retrieving different number of pixels from the imaging element in a series of operations, this method is a method to handle and control an image retrieved as a moving image (comparatively small number of pixels) and an image able to be handled as a still image (comparatively large number of pixels) on the same stream, it restores moving image quality as a still image by the predicted information from peripheral information of the still image even in timing able to obtain only moving image quality at the time of the above playback.

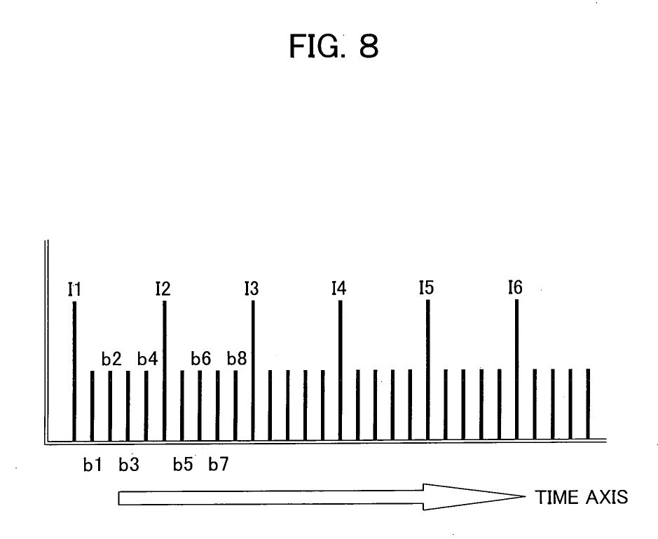

The stream mixed moving image (low pixel) and still image (high pixel) becomes as shown in FIG. 8.

Here, between image data of the high pixel (still image) In and image data of low pixel bn (moving image), there is a difference that In has information of one pixel and bn has information of integrated information in output image information corresponding to one pixels.

Further, since In can be integrated digitally, actually information in In has still image information and moving image information.

Here, object migration information making integrated information one block is calculated out from the moving image information bn including information predicted from In.

Further, containing ratio information of each integrated single pixel is obtained from In.

Therefore, for generation of still image for example b5 that has only information of number of pixels of moving image, if multiplying component ratio of each integrated single pixel predicted from fluctuation of In information, the pixel components are restored. By generating images from discrete single pixel information, images of still image quality can be produced. Further, because of the above-mentioned reason, image between b and b can be produced from the object migration information of bn and the containing ratio information of In.

As explained above, the imaging device 1 in the present first embodiment, when capturing moving images in the signal processing system compresses image data of high pixel with intra-frame compression to generate a first compressed image, compresses image data of low pixel with inter-frame compression in a front period and/or in a rear period of the period generating the first compressed image to generate a second compressed image and, when designating one screen of the second compressed image, the imaging device 1 performs decompression and decoding by the second compressed image and the other images including the first compressed image in front and/or in rear of the second compressed image to generate still image data having high-resolution showing one designated screen.

Then, the imaging device 1 according to the present embodiment, has an advantage of enabling to perform a continuous capturing at high speed with preventing generation of distortion of images because rolling shutter function and global shutter function are used together.

Then, the imaging device 1 according to the present embodiment has an advantage that correction of image level of the first compressed image and image level of the second compressed image with approximately equivalent level and generation of images of which luminance are different in series can be prevented.

Further, the imaging device 1 according to the present embodiment can convert a still image having high-resolution to image having low-resolution from data file, form a simple moving image file to reduce file size, be executed by an operator with a key operation and so on and make have spare to a remainder capacity of a memory when the operator judged that an image captured in a mode of mixing of a still image and a moving image is not necessary to be printed out and so on. Furthermore, it has an advantage that there is no problem that image quality deteriorates when playing back as a moving image because high-resolution information of the still image is only cut.

### Second Embodiment

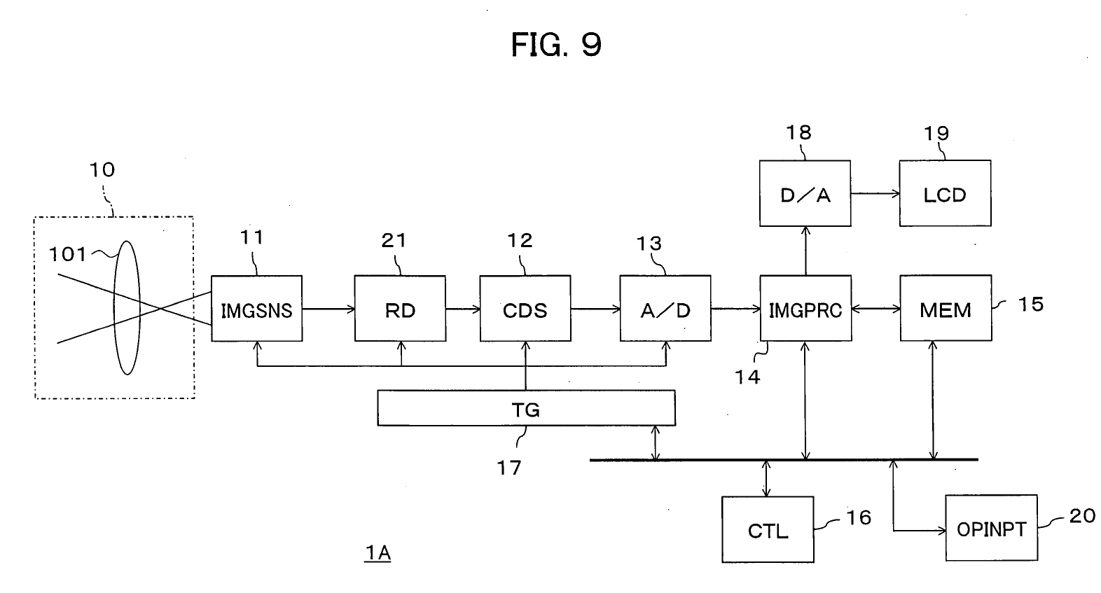

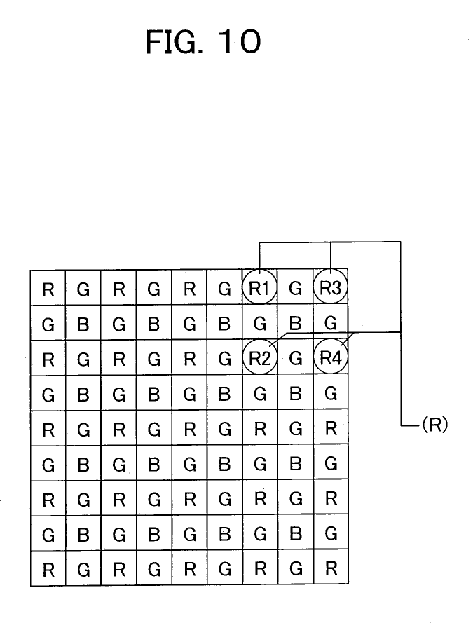

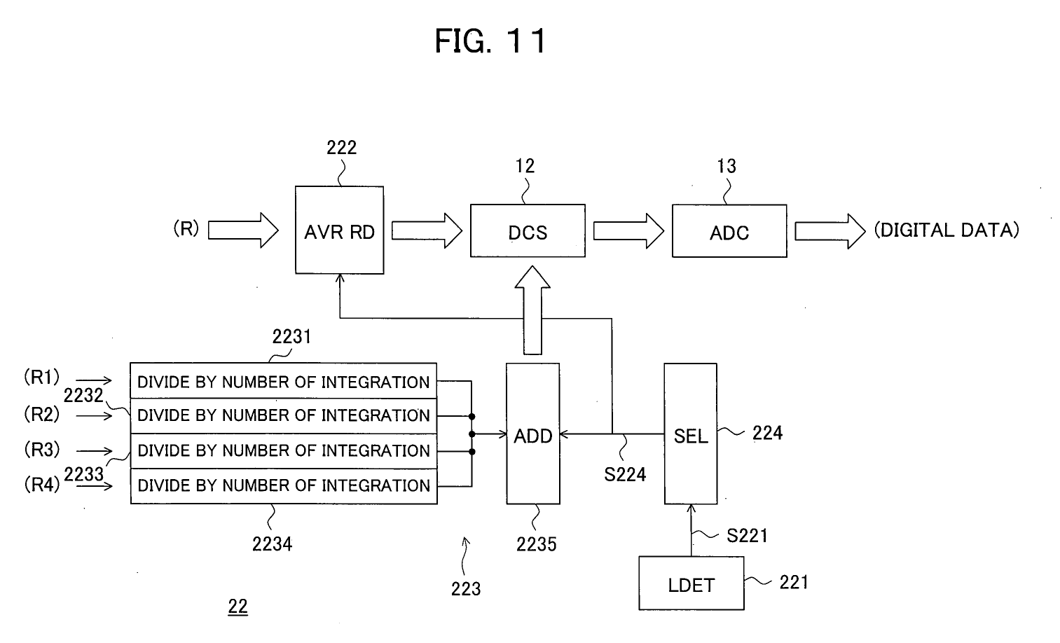

FIG. 9 is a block diagram showing the second embodiment of a point imaging device of the present invention.

The difference point of an imaging device 1A of the second embodiment from the above-mentioned imaging device 1 of the first embodiment resides in that the imaging device 1A has a readout circuit (RO) between an image sensor 11 and a CDS 12 and adopts an image readout control method of average/summing integration of pixels.

The readout circuit 12 is controlled timing by a timing generator 17. Since the other composition is similar to the first embodiment basically, hereinafter, composition and function of the readout circuit 21 will be explained mainly.

As mentioned above, in the present second embodiment, the readout circuit 21 is arranged and an image readout control method of average/summing integration of pixels is adopted.

Generally, when it may be capture of number of pixels smaller than an imaging element, data thinned pixels or performed summing integration processing is output. In the case of simple thinning, although structure is simple, since pixels are subtracted from the image, deterioration of the image is feared.

On the other hand, in the summing integration method, although it is structurally more complex than the simple sinning, since adding pixels, so-called rounded off information is included in the added data and it has an advantage hard to occur image quality deterioration compared with the simple thinning.

Further, since pixels are added, sensitivity in the appearance goes up, it has an advantage that much information can be charged even in the dark.

In the present second embodiment, a pixel control method explained hereinafter with including the above characteristics is adopted.

FIG. 10 is a conceptual view of an image sensor. Note that, RGB in FIG. 10 indicates red, green and blue of three primary colors.

In a view of the sensor as shown in FIG. 10, the R color is focused.

Usually, considering summing integration of four pixels, (R) as (R)=R1+R2+R3+R4 is used as an image output.

Usually, this (R) is converted to a digital signal by an A/D converter 13 in a later stage.

The A/D converter 13 is supplied with a reference voltage on A/D converting referred to as Vref voltage. The Vref voltage divided by number of predetermined bit becomes resolution of the A/D.

Usually, the reference voltage Vref is determined as the vicinity of saturation level of a single pixel is an upper limit.

Since (R) is a signal of summing level of a plurality of pixels, when imaging a bright subject (subject having high luminance), it may be saturated.

However, adversely, in the case of a dark subject (subject having low luminance), since a usual single pixel adds and captures even an output signal of a level buried in the noise, a predetermined signal level can be assured.

Concerning a pixel average, R1, R2, R3 and R4 are averaged at an analog level.

FIG. 10 is a circuit diagram showing an example of the readout circuit 21 composed based on the above.

This readout circuit 21 has a luminance detection section 221, an averaging readout circuit 222 as a pixel average readout circuit able to average a plurality of pixel data from the image sensor 11 and read out it, an addition readout circuit 223 as a pixel addition readout circuit able to add a plurality of pixel data from the image sensor 11 and read out it, and a selection circuit 224 selecting either output of the averaging readout circuit 222 and the addition readout circuit 223 by the detection output of the luminance detection circuit 221.

The addition readout circuit 223 has division circuits 2231 to 2234 and an addition circuit 2235.

This addition readout circuit 223 divides each input signals R1 to R4 by pre-set addition numbers in the division circuits 2231 to 2234 and then adds in the addition circuit 2235.

Since the output of information of average pixel by a circuit of FIG. 11 is almost the same as the output of a single pixel in comparison with information of the addition pixel, the output level is low in a dark place, however, since information of peripheral pixels are included, the level of the image quality deterioration is low and the noise level is low in comparison with the single pixel. Further, there is no problem of saturation when it is bright either.

Based on the above basis, the selection circuit 224 receives the information of brightness by the luminance detection section 221 (luminance information) S221 and compares a preset threshold N for judging whether pixel average is performed or pixel addition is performed.

When the luminance information is larger than the threshold N (S221>N), the selection circuit 224 deems it as a bright subject and outputs a selection signal S224 to select the averaging readout circuit 222.

On the other hand, when the luminance information is N or less than the threshold N (S221<N), the selection circuit 224 deems it as a dark subject and outputs a selection signal S224 to select the addition readout circuit 223.

As mentioned above, since an imaging device 1A in the present second embodiment has a readout circuit 21 including a function to average and read out and a function to add and read out a plurality of pixel data output from a plurality of imaging elements of an image sensor 11 and selecting whether read out averaged data in accordance with the luminance of a subject is read output averaged data is read out and outputted or added data is readout and outputting selected data, the imaging device 1A has an advantage that the output is not saturated at a bright subject and the degree of the image quality deterioration can be suppressed to low at a dark subject in addition to an advantage of the above-mentioned first embodiment.

### Third Embodiment

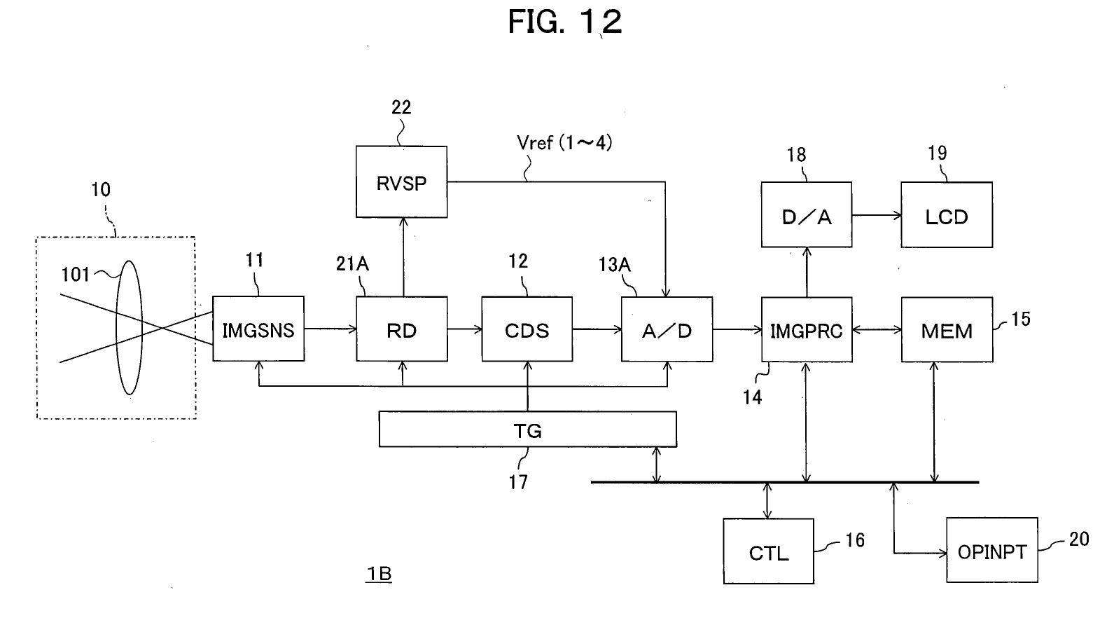

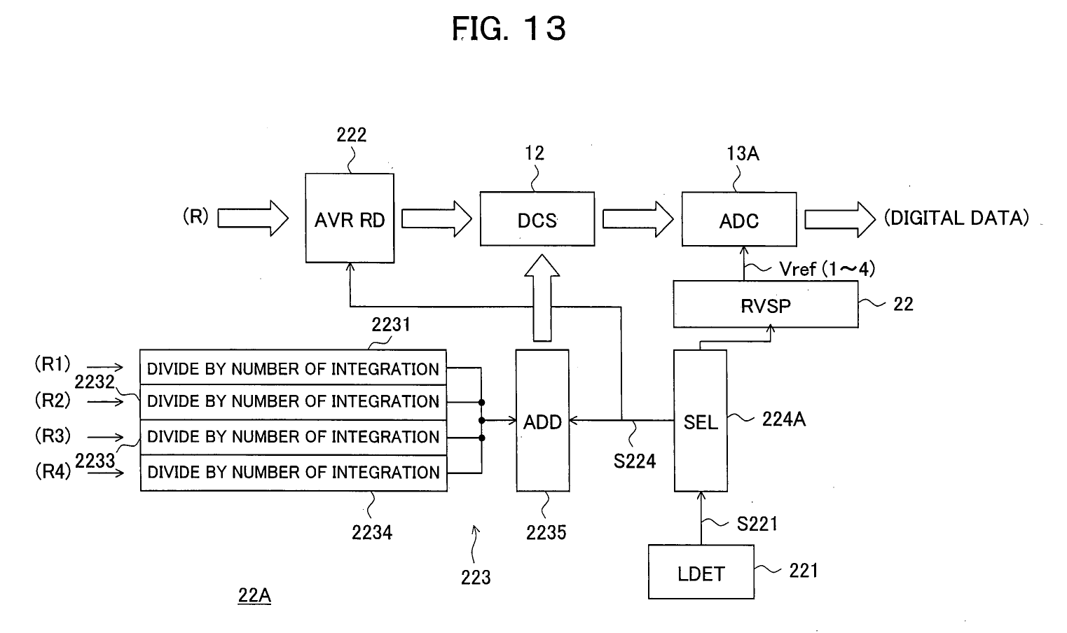

FIG. 12 is a block diagram showing a third embodiment of an imaging device according to the present invention. FIG. 13 is a block diagram showing an example of a configuration of a readout circuit according to the third embodiment.

The difference point of an imaging device 1B of the present third embodiment from the imaging device of the above-mentioned second embodiment resides in that the readout circuit 21A selects average (high luminance to normal luminance), addition of a first predetermined amount (somewhat low luminance), addition of a second predetermined amount (middle low luminance) and addition of a third predetermined amount (fairly low luminance) in accordance with the luminance, changes a reference voltage Vref of an A/D converter 13A in accordance with a degree of the addition and suppresses a fluctuation of the level.

Concretely, a reference voltage supply circuit (RVSP) 22 is designated so that when the selection circuit 224A selects averaging readout processing, a reference voltage Vref1 is supplied to the A/D converter 13A, when it selects addition of a first predetermined amount, a reference voltage Vref2 is supplied to the A/D converter 13A, when it selects addition of a second predetermined amount, a reference voltage Vref3 is supplied to the A/D converter 13A and when it selects addition of a third predetermined amount, a reference voltage Vref4 is supplied to the A/D converter 13A.

In this case, the selection circuit 224A functions as a number of added pixels changing circuit, and the selection circuit 224A and the reference voltage supply circuit 22 functions as a reference voltage changing circuit.

The other composition is similar to the second embodiment.

The present third embodiment has an advantage that a fluctuation of the level by a change of the luminance can be suppressed adequately.

While the invention has been described with reference to specific embodiments chosen for purpose of illustration, it should be apparent that numerous modifications could be made thereto by those skilled in the art without departing from the basic concept and scope of the invention.

1. An imaging device comprising:
an imaging element on which an optical image of a subject is formed;
a signal processing system reading out high image data having high-resolution or low image data having low-resolution from the imaging element and performing predetermined image processing for read out image data,
wherein the signal processing system includes
an image processing section generating a first compressed image compressed the high image data with intra-frame compression in capturing one moving image data and a second compressed image compressed the low image data with inter-frame compression in a front period and/or in a rear period of a period generating the first compressed image as one stream.

2. An imaging device as set forth in claim 1, wherein
the high image data includes image data read out from the imaging element without thinning or image data read out with thinning by any amount of thinning by the image processing system, and
the low image data includes image data read out from the imaging element with thinning by any amount of thinning to become lower resolution than the high image data by the image processing system.

3. An imaging device as set forth in claim 1, comprising a global shutter function and a rolling shutter function as shutter function,
wherein the image processing section generates a first compressed image by image data captured with the global shutter and generates a second compressed image by image data captured with the rolling shutter.

4. An imaging device as set forth in claim 2, wherein
the image processing section corrects an image level of the first compressed image and an image level of the second compressed image to be an approximately equivalent level.

5. An imaging device as set forth in claim 1, wherein
when one screen of the second compressed image is designated, the image processing section generates still image data having high-resolution indicating the one designated screen by decompression and decoding a screen of the second compressed image by the other image including the first compressed image in front and/or in rear of the second compressed image.

6. An imaging device as set forth in claim 1, further comprising:
a stream output unit outputting a continuous video stream having low-resolution by using the first compressed image having high-resolution and the second compressed image having low-resolution;
a discrimination unit discriminating whether the first compressed image is high-resolution or low-resolution, and
a discrimination signal output unit outputting a signal indicating whether the first compressed image is high-resolution or low-resolution by the discrimination unit.

7. An imaging device as ser forth in claim 1, comprising:
storing unit storing a series of stream data of the first compressed image and the second compressed image,
wherein when one screen of the first compressed image on one stream data is designated, the image processing section reduces resolution of the first compressed image to the equivalent degree of the second compressed image, replaces the first compressed image in the stream data to the first compressed image which resolution is reduced and restores it in the storing unit.

8. An imaging device as set forth in claim 8, comprising:
storing unit storing a series of stream data of the first compressed image and the second compressed image,
wherein the image processing section reduces resolution of all of a plurality of the first compressed images on one stream data to the equivalent degree of the second compressed image, replaces the first compressed image in the stream data to the first compressed image which resolution is reduced and restores it in the storing unit.

9. An imaging device as set forth in claim 4,
wherein when reading out image data from the imaging element with thinning, the signal processing system generates thinning data by performing integration processing of concolorous vicinity pixels.

10. An imaging device as set forth in claim 4,
wherein the image processing section corrects an image level of the first compressed image and an image level of the second compressed image to be an approximately equivalent level by correcting an image level of the first compressed image based on an R level performed integration processing readout of the second compressed image.

11. An imaging device as set forth in claim 9,
wherein the image processing section corrects an image level of the first compressed image and an image level of the second compressed image to be an approximately equivalent level by maintaining an image level of the first compressed image and correcting an image level of the second compressed image by dividing an integration amount of the integration processing.

12. An imaging device as set forth in claim 1,
wherein the signal processing system includes
a pixel average readout circuit able to average and read out a plurality of pixel data from the imaging element,
a pixel addition readout circuit able to add and read out a plurality of pixel data from the imaging element,
a luminance detector detecting the luminance of a subject, and
a selector selecting either output of the pixel average readout circuit and the pixel addition readout circuit by detection output of the luminance detector.

13. An imaging device as set forth in claim 12,
wherein the signal processing system includes
an added pixel changing circuit changing number of added pixels in the pixel addition readout circuit based on output of the luminance detector,
a converter converting output data of the pixel addition readout circuit or the pixel average readout circuit selected by the selector from analog data to digital data, and
a reference voltage changing circuit changing a reference voltage value of the converter based on output of the luminance detector or output of the added pixel readout circuit.

14. An image generation method of an imaging device performing predetermined image processing for image data read out from an imaging element, comprising steps of:
reading out high image data having high-resolution or low image data having low-resolution from the imaging element by making an optical image of a subject to form on the imaging element;
generating a first compressed image by compressing the high image data with intra-frame compression in capturing single moving image data;
generating a second compressed image by compressing the low image data with inter-frame compression in a front period and/or in a rear period of a period generating the first compressed image, and
generating a first compressed image compressed the high image data with intra-frame compression and a second compressed image compressed the low image data with inter-frame compression in a front period and/or in a rear period of a period generating the first compressed image as one stream.
